(19) United States
(12) Patent Application Publication
(10) Pub. No.: US 2026/0072730 A1
(43) Pub. Date: Mar. 12, 2026

(54) OPTIMIZED ORCHESTRATION IN FEDERATED INFERENCE ACROSS MOBILE DEVICES

(71) Applicant: INTERNATIONAL BUSINESS MACHINES CORPORATION, ARMONK, NY (US)

(72) Inventors: Alecio Pedro Delazari Binotto, Munich (DE); Fernando Luiz Koch, Palm Beach Gardens, FL (US); Francis Powlesland, Muenchen (DE)

(21) Appl. No.: 18/828,989

(22) Filed: Sep. 9, 2024

(51) Int. Cl. G06F 9/48

(52) U.S. Cl. CPC G06F 9/4843

(57) ABSTRACT

Rule-based decision is augmented by adaptively partitioning artificial intelligence (AI) workloads across a federated inference infrastructure based on real-time assessments of device capabilities, network conditions, and workload requirements. Inference demands are partitioned to distribute tasks, while supporting mobile device heterogeneity.

### BACKGROUND

Embodiments relate to a method, system, and computer program product for optimized orchestration in federated inference across mobile devices.

As generative artificial intelligence (AI) adoption increases, there is a greater demand for computing power. Processing in generative AI may be distributed between the cloud and devices for scalability. In certain mobile networks, the cloud and edge devices, such as smartphones, may operate together to deliver more efficient solutions to AI problems.

In certain machine learning (ML) mechanisms, large language models (LLM) may be built on top of transformer decoders. LLMs may perform Natural Language Processing (NLP) or other tasks. LLMs are usually deployed on servers for inference serving. Server based inference serving may be inefficient if Internet connectivity is slow. Mobile computing that processes data at the source or close to the source may reduce the need for bandwidth. However, mobile devices frequently have limited processing capabilities and memory, making it challenging to incorporate LLMs. Deploying LLMs on resource-limited mobile devices may be performed via various mechanisms.

Federated learning is a type of machine learning (ML) in which multiple clients collaboratively train a model while ensuring that their data remains decentralized. This is in contrast to mechanisms in certain other types of machine learning in which data is centrally stored. In federated learning the emphasis is on training machine learning models collaboratively across decentralized devices while preserving data privacy. Orchestration refers to actions a controller performs in setting up devices, applications, and services in a mobile network to achieve certain objectives during federated learning and inference generation.

### SUMMARY

Provided are a method, system, and computer program product in which rule-based decision is augmented by adaptively partitioning artificial intelligence (AI) workloads across a federated inference infrastructure based on real-time assessments of device capabilities, network conditions, and workload requirements. Inference demands are partitioned to distribute tasks, while supporting mobile device heterogeneity.

In additional embodiments, computational capabilities of each mobile device, including available Central Processing Unit (CPU), Graphics Processing Unit (GPU), memory resources, and specialized AI inference System on Chips (SoCs) are analyzed. Continuous monitoring of network conditions, including bandwidth and latency, to ensure efficient distribution of tasks is performed. Machine learning techniques are employed to adaptively adjust workload partitioning based on historical data and real-time feedback.

In further embodiments, operations are performed to dynamically balance workload distribution across the federated inference infrastructure to prevent overloading and maximize processing efficiency by analyzing SoC characteristics.

In yet further embodiments, rule-based decision and Large AI models are employed to predict future workload demands and recommend task migration, wherein tasks are dynamically reassigned from overloaded devices to underutilized ones, ensuring optimal resource utilization across a federated network.

In certain embodiments, fault-tolerance strategies are employed for the federated inference infrastructure, including mechanisms for detecting and handling device failures, network disruptions and well as characteristics of foundation models.

In additional embodiments, operations are performed for implementing rule-based decision around task replication and employing redundancy to mitigate impact of device failures or network disruptions.

In certain embodiments, machine learning is employed to predict potential failures and proactively mitigating the potential failures to maintain uninterrupted AI inference.

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments.

FIG. 2 illustrates a block diagram that shows operations for management and orchestration of a federated network of mobile devices, in accordance with certain embodiments.

FIG. 3 illustrates a flowchart that shows operations for dynamic workload partitioning in the federated inference architecture, in accordance with certain embodiments.

FIG. 4 illustrates a flowchart that shows operations for recommending load balancing strategies for the federated inference architecture, in accordance with certain embodiments.

FIG. 5 illustrates a flowchart that shows operations for ensuring fault-tolerance in distributed model inference in the federated inference architecture, in accordance with certain embodiments.

FIG. 6 illustrates a flowchart that shows exemplary operations, in accordance with certain embodiments.

FIG. 7 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Several examples will now be provided to further clarify various aspects of the present invention:

Example 1: A method in which rule-based decision is augmented by adaptively partitioning artificial intelligence (AI) workloads across a federated inference infrastructure based on real-time assessments of device capabilities, network conditions, and workload requirements. Inference demands are partitioned to distribute tasks, while supporting mobile device heterogeneity. As a result, processing performance is improved in a network.

Example 2: The limitations of Example 1, where computational capabilities of each mobile device, including available Central Processing Unit (CPU), Graphics Processing Unit (GPU), memory resources, and specialized AI inference System on Chips (SoCs) are analyzed. Continuous monitoring of network conditions, including bandwidth and latency, to ensure efficient distribution of tasks is performed. Machine learning techniques are employed to adaptively adjust workload partitioning based on historical data and real-time feedback. As a result, tasks are distributed efficiently in a network.

Example 3: The limitations of any of Examples 1-2, where operations are performed to dynamically balance workload distribution across the federated inference infrastructure to prevent overloading and maximize processing efficiency by analyzing SoC characteristics. As a result, workloads are balanced for improving processing in a network.

Example 4: The limitations of any of Examples 1-3, where rule-based decision and Large AI models are employed to predict future workload demands and recommend task migration, wherein tasks are dynamically reassigned from overloaded devices to underutilized ones, ensuring optimal resource utilization across a federated network. As a result, resources are utilized optimally in a network.

Example 5: The limitations of any of Examples 1-4, where fault-tolerance strategies are employed for the federated inference infrastructure, including mechanisms for detecting and handling device failures, network disruptions and well as characteristics of foundation models. As a result, failures and disruptions are handled in a network.

Example 6: The limitations of any of Examples 1-5, where operations are performed for implementing rule-based decision around task replication and employing redundancy to mitigate impact of device failures or network disruptions. As a result, redundancy is employed to reduce the impact of failures.

Example 7: The limitations of any of Examples 1-6, where machine learning is employed to predict potential failures and proactively mitigating the potential failures to maintain uninterrupted AI inference. As a result, the impact of failures is decreased in a network.

Example 8: A system comprising a memory and a processor coupled to the memory, where the processor performs a method according to any of Examples 1-7. As a result, processing performance is improved in a network.

Example 9: A computer program product comprising a computer readable storage medium having computer readable program code embodied therewith, where the computer readable program code when executed is configured to perform a method according to any of Examples 1-7. As a result, processing performance is improved in a network.

A system on a chip (SoC) is an integrated circuit that compresses all of a system's required components onto one piece of silicon. Mobile devices equipped with specialized AI inference system SoCs may be able to process the inference of large AI models. This brings the possibility to interconnect and orchestrate large AI inference load through mobile devices in specific regions to distribute AI workloads efficiently and process data closer to the source, minimizing latency and reducing reliance on centralized infrastructure. Such a distributed approach not only improves scalability and responsiveness but also enhances data privacy by keeping sensitive information localized and minimizes the need for data transfer across networks. The problems revolve around coherent inference partitioning of large AI Models, convergence of distributed models, coordination and optimization of workload distribution, and coping with inherent issues of mobile environments, such as movement patterns, energy consumption, network conditions, workload requirements, and others.

In certain embodiments, numerous mobile devices equipped with specialized AI inference SoCs form a federated network for real-time data analysis and inference. The federated inference infrastructure dynamically orchestrates workload distribution based on the fluctuating demands for AI inference tasks driven by various social dynamics such as population movements, gatherings, and events like festivals or emergencies. As an example, during a city-wide event, such as a music festival, the demand for AI inference tasks related to crowd management, traffic optimization, and event monitoring increases dramatically. The federated infrastructure efficiently allocates these tasks to nearby mobile devices with available computational resources, minimizing latency and maximizing processing efficiency. Meanwhile, in other parts of the city where demand is lower, devices contribute to the workload by processing less intensive tasks or remaining on standby, ensuring optimal resource utilization across the federated network. This use case highlights the ability of the embodiments to adapt dynamically to changing environmental conditions and effectively leverage distributed AI processing for real-time decision-making in complex urban settings.

Certain embodiments provide an optimized federated workload distribution aiming at confederation of mobile devices equipped with specialized AI inference SoCs, providing mechanisms to dynamically form federated groups of devices based on real-time assessments of capabilities, providing workload partitioning and load balancing mechanisms, and providing fault tolerance strategies able to cope with the nature of mobile environments.

The problems addressed by certain embodiments include:
(i) How to efficiently distribute AI workload across multiple mobile devices equipped with specialized SoCs in a nearby region?
(ii) How to dynamically adjust workload partitioning based on real-time assessments of device capabilities and network conditions?
(iii) How to balance the workload distribution among devices to prevent overloading and maximize processing efficiency?
(iv) How to adapt task assignments and workload distribution in real-time based on changing conditions inherent to mobile computing environment?
(v) How to adapt the workload distribution system to different use cases and application domains, ensuring flexibility and scalability?

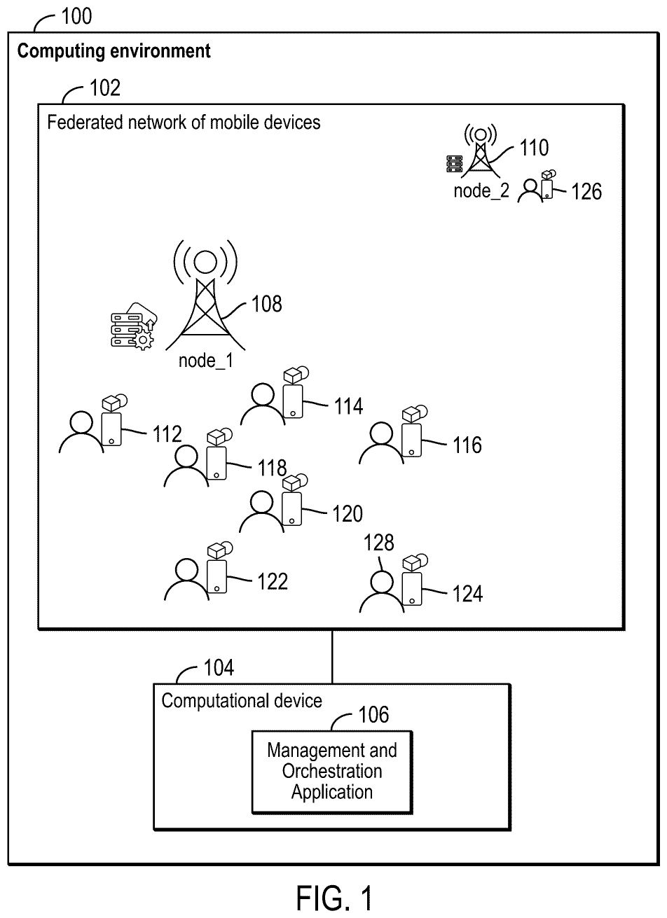

FIG. 1 illustrates a block diagram of a computing environment 100, in accordance with certain embodiments.

The computing environment 100 is comprised of a federated network of mobile devices 102, where a computational device 104 that executes a management and orchestration application 106 performs an optimized orchestration in federated inference across the mobile devices in the federated network of mobile devices 102. The term federated infrastructure is used to collectively refer to the federated network of mobile devices 102 and the computational device 104.

The federated network of mobile devices 102 may be comprised of one or more cellular base stations referred to as node_1 108 and node_2 110. A plurality of mobile devices 112, 114, 116, 118, 120, 122, 124 are shown to communicate via the cellular base station named node_1 108, and a mobile device 126 is shown to communicated via the cellular based station named node_2 110. In FIG. 1, a crowd of users (an exemplary user is shown via reference numeral 128) has gathered in the vicinity of the cellular base station node_1 108 that services the plurality of mobile devices 112, 114, 116, 118, 120, 122, 124.

The mobile devices 112, 114, 116, 120, 122, 124, 126 are equipped with specialized AI inference SoCs and collaborate for real-time data analysis and inference. The federated infrastructure depicted in the computing environment 100 dynamically distributes AI workload based on fluctuating demands influenced by social dynamics like population movements. The infrastructure efficiently assigns tasks to nearby devices with available resources, minimizing latency and maximizing processing efficiency.

The computational device 104 may in certain embodiments comprise any suitable computational device known in the art such as a server, a personal computer, a laptop, a mainframe, etc. The management and orchestration application 106 that executes in the computational device 104 may in certain embodiments be implemented in software, firmware, hardware or any combination thereof.

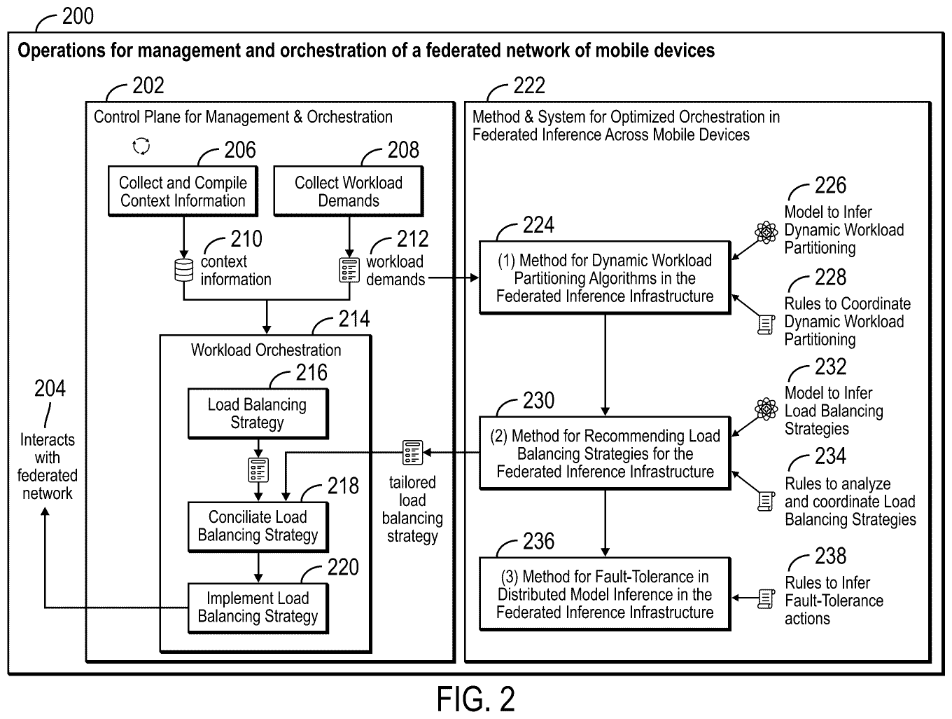

FIG. 2 illustrates a block diagram 200 that shows operations for management and orchestration of a federated network of mobile devices, in accordance with certain embodiments. FIG. 2 shows operations in which mobile devices equipped with specialized AI inference SoCs on a specific region are able to provide local resources for query inference. A pre-configured set of models are loaded to the local environment and are able to process certain requests related to demand. Moreover, the environment has the ability to dynamically load or unload AI models based on new or changing demand.

A control plane for management and orchestration 202 that interacts (as shown via reference numeral 204) with the federated network of mobile devices 102 is shown in FIG. 2.

Context information is collected and compiled (shown via reference numeral 206) and workload demands are collected (shown via reference numeral 208). The context information 210 and the workload demands 212 are provided as input for workload orchestration 214.

In workload orchestration 214, the devices collaborate either through peer-to-peer networks or Mobile Edge Cloud infrastructure to form a federated network. Workload orchestration mechanisms facilitate the efficient allocation of AI inference tasks across these devices, forming the Federated Inference Infrastructure. Workload orchestration includes performing operations for load balancing strategy 216, conciliating the load balancing strategies 218, and implementing load balancing strategies 220.

The management and orchestration application performs resource sharing and collaboration in which devices collaborate to optimize resource utilization and minimize latency by sharing computational resources; this approach enables tasks to be processed closer to the data source, reducing reliance on centralized infrastructure and enhancing scalability and responsiveness.

Dynamic demand scenarios may occur in certain social settings. The region where the Federated Inference Infrastructure operates is characterized by a vibrant social setting, influenced by diverse activities and events. These social dynamics contribute to fluctuating demands for AI inference tasks, which are driven by factors such as population movements, gatherings, and specific events like festivals, conferences, or emergency situations such as disaster recovery efforts.

Certain embodiments leverage large generative models combined with rule-based inference to promote dynamic workload partitioning and load balancing on federated orchestration of AI inference through dynamic clusters of mobile devices as shown in the block 222 labeled as method and system for optimized orchestration in federated inference across mobile devices.

In block 222, control starts at block 224 that shows a method for dynamic workload partitioning in the Federated Inference Infrastructure which provides the mechanisms to combine rule-based decision for adaptively partitioning AI workloads across the Federated Inference Infrastructure based on real-time assessments of device capabilities, network conditions, and workload requirements. This method aims to partition the inference demands to efficiently distribute tasks to minimize latency and maximize processing efficiency. It works by analyzing the computational capabilities of each mobile device, including factors such as available CPU, GPU, and memory resources, as well as the specialized AI inference SoCs. Additionally, it continuously monitors network conditions, such as bandwidth and latency, to ensure efficient distribution of tasks. Machine learning techniques are employed to adaptively adjust workload partitioning based on historical data and real-time feedback. Models 226 to infer dynamic workload partitioning and rules 228 to coordinate dynamic workload partitioning are employed.

From block 224 control proceeds to block 230 which shows a method for recommending load balancing strategies for the Federated Inference Infrastructure. This provides the algorithms to dynamically balance the workload distribution across the Federated Inference Infrastructure to prevent overloading and maximize processing efficiency. It employs rule-based decision and Large AI models to predict future workload demands and recommend task migration, where tasks are dynamically reassigned from overloaded devices to underutilized ones, ensuring optimal resource utilization across the federated network. Models 232 to infer load balancing strategies and rules 234 to analyze and coordinate load balancing strategies are employed.

After execution of block 230, control proceeds to block 236 in which a method for ensuring fault-tolerance in distributed model inference in the Federated Inference Infrastructure is performed. This provides the mechanisms to implement fault-tolerance strategies for the Federated Inference Infrastructure, including mechanisms for detecting and handling device failures, network disruptions, and other challenges inherent in dynamic and resource-constrained settings. It works by implementing rule-based decisions around task replication and redundancy is employed to mitigate the impact of device failures or network disruptions. Machine learning algorithms are utilized to predict potential failures and proactively mitigate them to maintain uninterrupted AI inference. The operations also employ the depicted rules 238 to infer fault-tolerance actions.

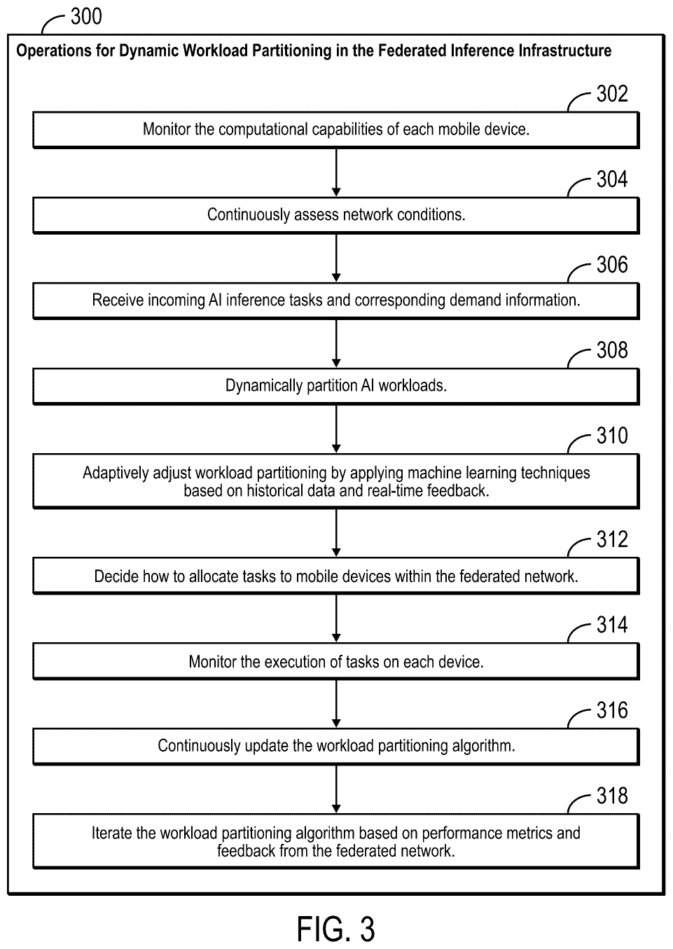

FIG. 3 illustrates a flowchart 300 that shows operations for dynamic workload partitioning in the federated inference architecture, in accordance with certain embodiments. The operations shown in FIG. 3 may be performed by a process corresponding to the management and orchestration application 106.

Consider that embodiments have Large Generative Models fine-tuned for decisions on load distribution, based on real-time assessments of device capabilities, network conditions, and workload requirements, and other factors. Considering that these Large Generative Models have been trained to effectively analyze and interpret the intricate interplay of various parameters, including the computational capabilities of individual mobile devices, the prevailing network conditions such as bandwidth availability and latency, and the specific demands of incoming AI inference tasks, the operations performed in FIG. 3 are performed for dynamic workload partitioning as described below.

Control starts at block 302 in which the process monitors the computational capabilities of each mobile device by gathering information about available Central Processing Unit (CPU), Graphics Processing Unit (GPU), memory resources, and specialized AI inference SoCs.

Control proceeds to block 304 in which the process continuously assesses network conditions by applying rule-based decision-making to assess factors like bandwidth and latency to ensure efficient distribution of tasks across the federated network.

From block 304 control proceeds to block 306 in which the process receives incoming AI inference tasks and corresponding demand information. Then the process dynamically partitions (at block 308) AI workloads through a combination of rule-based decision and/or Large Generative models fine-tuned for decisions on load distribution, based on real-time assessments of device capabilities, network conditions, and workload requirements.

From block 308 control proceeds to block 310 in which the process adaptively adjusts workload partitioning by applying machine learning techniques based on historical data and real-time feedback. Then the process decides (at block 312) how to allocate tasks to mobile devices within the federated network through rule-based inference considering factors such as computational capabilities, proximity to data sources, and current workload.

From block 312 control proceeds to block 314 in which the process monitors the execution of tasks on each device and dynamically adjusts workload distribution as needed to optimize resource utilization and minimize latency. Then the process continuously updates (at block 316) the workload partitioning algorithm based on evolving demand scenarios and changes in device capabilities or network conditions. The process iterates (at block 318) the workload partitioning operations based on performance metrics and feedback from the federated network, aiming to further improve processing efficiency and scalability.

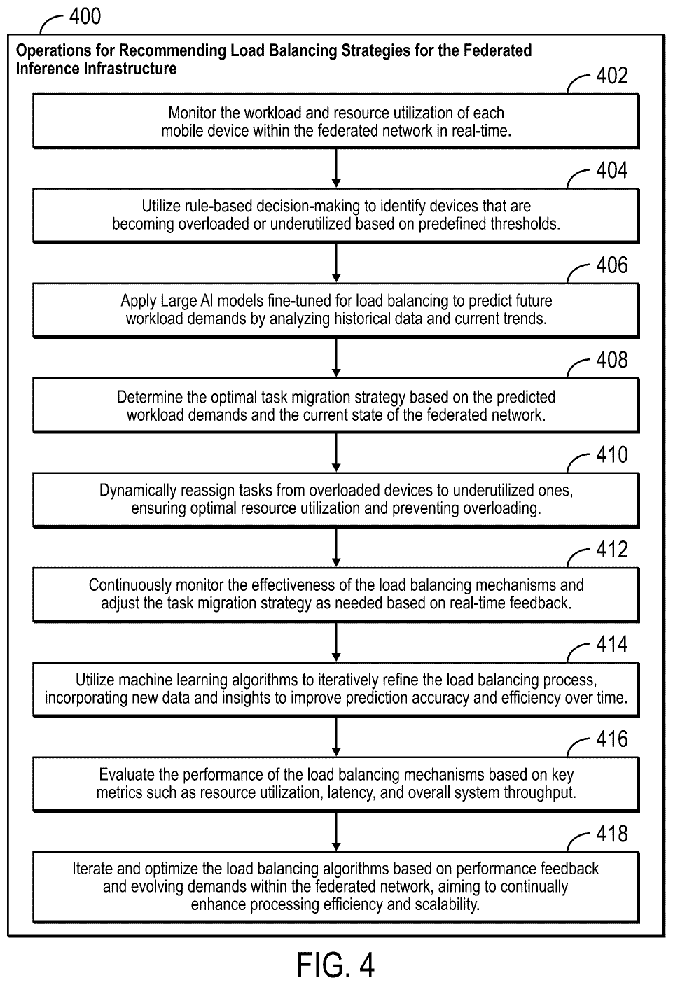

FIG. 4 illustrates a flowchart 400 that shows operations for recommending load balancing strategies for the federated inference architecture, in accordance with certain embodiments. The operations shown in FIG. 4 may be performed by a process corresponding to the management and orchestration application 106.

Control starts at block 402 in which the process monitors the workload and resource utilization of each mobile device within the federated network in real-time. Then the process utilizes (at block 404) rule-based decision-making to identify devices that are becoming overloaded or underutilized based on predefined thresholds. Control then proceeds to block 406 in which the process applies Large AI models fine-tuned for load balancing to predict future workload demands by analyzing historical data and current trends.

From block 406 control proceeds to block 408 in which the process determines the optimal task migration strategy based on the predicted workload demands and the current state of the federated network. Then the process dynamically reassigns (at block 410) tasks from overloaded devices to underutilized ones, ensuring optimal resource utilization and preventing overloading. The process continuously monitors (at block 412) the effectiveness of the load balancing mechanisms and adjusts the task migration strategy as needed based on real-time feedback.

From block 412 control proceeds to block 414 in which the process utilizes machine learning algorithms to iteratively refine the load balancing process, incorporating new data and insights to improve prediction accuracy and efficiency over time. Then the process evaluates (at block 416) the performance of the load balancing mechanisms based on key metrics such as resource utilization, latency, and overall system throughput. Control proceeds to block 418 where the process proceeds to iterate and optimize the load balancing algorithms based on performance feedback and evolving demands within the federated network, aiming to continually enhance processing efficiency and scalability.

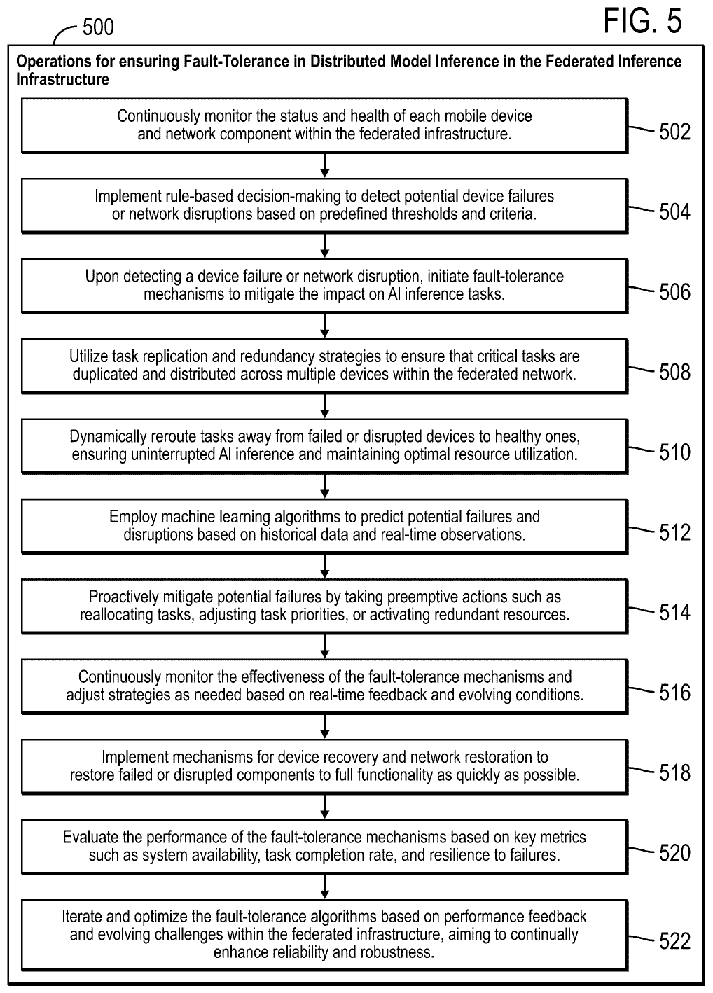

FIG. 5 illustrates a flowchart 500 that shows operations for ensuring fault-tolerance in distributed model inference in the federated inference architecture, in accordance with certain embodiments. The operations shown in FIG. 5 may be performed by a process corresponding to the management and orchestration application 106.

Control starts at block 502 in which a process continuously monitors the status and health of each mobile device and network component within the federated infrastructure. Then the process implements (at block 504) rule-based decision-making to detect potential device failures or network disruptions based on predefined thresholds and criteria. Upon detecting a device failure or network disruption, the process initiates (at block 506) fault-tolerance mechanisms to mitigate the impact on AI inference tasks. The process then utilizes (at block 508) task replication and redundancy strategies to ensure that critical tasks are duplicated and distributed across multiple devices within the federated network.

From block 508 control proceeds to block 510 in which the process dynamically reroutes tasks away from failed or disrupted devices to healthy ones, ensuring uninterrupted AI inference and maintaining optimal resource utilization. The process employs machine learning algorithms to predict (at block 512) potential failures and disruptions based on historical data and real-time observations. Then the process proactively mitigates potential failures by taking preemptive actions such as reallocating tasks, adjusting task priorities, or activating redundant resources (at block 514). The process then continuously monitors (at block 516) the effectiveness of the fault-tolerance mechanisms and adjust strategies as needed based on real-time feedback and evolving conditions.

From block 516 control proceeds to block 518 where the process implements mechanisms for device recovery and network restoration to restore failed or disrupted components to full functionality as quickly as possible. The process then evaluates (at block 520) the performance of the fault-tolerance mechanisms based on key metrics such as system availability, task completion rate, and resilience to failures. Control proceeds to block 522 in which the process iterates and optimizes the fault-tolerance algorithms based on performance feedback and evolving challenges within the federated infrastructure, aiming to continually enhance reliability and robustness.

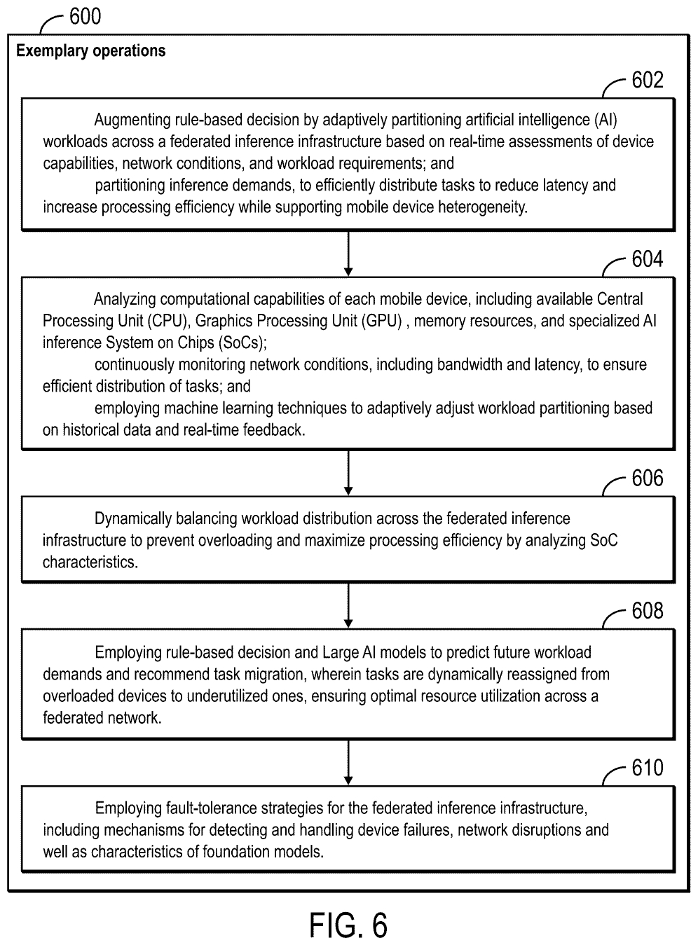

FIG. 6 illustrates a flowchart 600 that shows exemplary operations, in accordance with certain embodiments. The operations performed in FIG. 6 may be performed by the management and orchestration application 106.

Control starts at block 602 in which rule-based decision is augmented by adaptively partitioning artificial intelligence (AI) workloads across a federated inference infrastructure based on real-time assessments of device capabilities, network conditions, and workload requirements. Inference demands are partitioned, to efficiently distribute tasks to reduce latency and increase processing efficiency while supporting mobile device heterogeneity.

From block 602 control proceeds to block 604 in which computational capabilities of each mobile device, including available Central Processing Unit (CPU), Graphics Processing Unit (GPU), memory resources, and specialized AI inference System on Chips (SoCs) are analyzed. Continuous monitoring of network conditions, including bandwidth and latency, to ensure efficient distribution of tasks is performed. Machine learning techniques are employed to adaptively adjust workload partitioning based on historical data and real-time feedback.

Subsequently at block 606, operations are performed to dynamically balance workload distribution across the federated inference infrastructure to prevent overloading and maximize processing efficiency by analyzing SoC characteristics.

From block 606 control proceeds to block 608 in which rule-based decision and Large AI models are employed to predict future workload demands and recommend task migration, wherein tasks are dynamically reassigned from overloaded devices to underutilized ones, ensuring optimal resource utilization across a federated network. Fault-tolerance strategies are employed (at block 610) for the federated inference infrastructure, including mechanisms for detecting and handling device failures, network disruptions and well as characteristics of foundation models.

Therefore, FIGS. 1-6 illustrate certain embodiments for optimized orchestration in federated inference across mobile devices. This results in an improvement in machine learning mechanisms in computing systems.

Certain embodiments augment rule-based decision by adaptively partitioning AI workloads across the Federated Inference Infrastructure based on real-time assessments of device capabilities, network conditions, and workload requirements. Such embodiments aim to partition the inference demands to efficiently distribute tasks to minimize latency and maximize processing efficiency given device heterogeneity.

Certain embodiments implement mechanisms that work by analyzing the computational capabilities of each mobile device, including factors such as available central processing unit (CPU), graphic processing unit (GPU), and memory resources, as well as the specialized AI inference SoCs. Additionally, certain embodiments continuously monitor network conditions, such as bandwidth and latency, to ensure efficient distribution of tasks. Machine learning techniques are employed to adaptively adjust workload partitioning based on historical data and real-time feedback.

Certain embodiments dynamically balance the workload distribution across the Federated Inference Infrastructure to prevent overloading and maximize processing efficiency by analyzing the SoCs characteristics with the foundation model architectures and parameters to handle.

Certain embodiments employ rule-based decision and Large AI models to predict future workload demands and recommend task migration, where tasks are dynamically reassigned from overloaded devices to underutilized ones, ensuring optimal resource utilization across the federated network.

Certain embodiments provide fault-tolerance strategies for the Federated Inference Infrastructure, including mechanisms for detecting and handling device failures, network disruptions and well as characteristics of foundation models like catastrophic forgetting, and other challenges inherent in dynamic and resource-constrained settings.

Certain embodiments may implement rule-based decision around task replication and redundancy and are employed to mitigate the impact of device failures or network disruptions. Machine learning algorithms are utilized to predict potential failures and proactively mitigate them to maintain uninterrupted AI inference, like in a conversational application.

In contrast to certain embodiments, Mesh computing provides mechanisms in which devices collaborate in a decentralized manner without a central orchestrator, as the proposed system involves dynamic workload orchestration and optimization mechanisms guided by real-time assessments and adaptive decision-making. In contrast, the embodiments introduce an approach that not only facilitates dynamic workload orchestration but also incorporates real-time assessments and adaptive decision-making to optimize resource utilization and enhance processing efficiency across the federated network.

In contrast to certain embodiments, Mobile Grid Computing provides mechanisms where the emphasis is on harnessing aggregated computational power for specific tasks. Certain embodiments, on the other hand, focus on optimizing federated inference across mobile devices equipped with specialized AI inference SoCs.

In Federated Learning the emphasis is on training machine learning models collaboratively across decentralized devices while preserving data privacy. Certain embodiments focus on optimizing inference tasks across federated mobile devices in real-time, leveraging dynamic workload orchestration and adaptive decision-making to enhance processing efficiency and scalability without necessarily involving model training.

Distributed AI in Edge Computing is a mechanism where the emphasis is on deploying AI models and algorithms directly on edge devices to enable real-time data processing and decision-making, often without the need for constant communication with a central server. In contrast, certain embodiments extend beyond simple deployment to include dynamic workload orchestration and optimization across federated mobile devices, leveraging real-time assessments and adaptive decision-making to maximize processing efficiency and scalability while minimizing latency and reliance on centralized infrastructure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

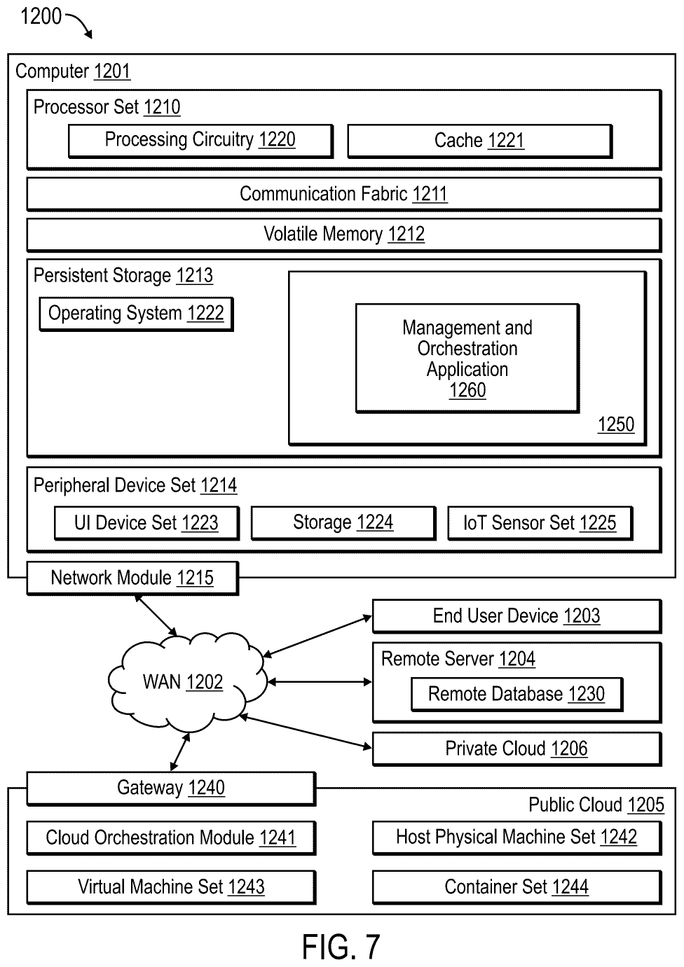

In FIG. 7, a computing environment 1200 contains an example of an environment for the execution of at least some of the computer code (block 1250) involved in performing the operations for a management and orchestration application 1260 that performs operations shown in FIGS. 1-6.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 6. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer, and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is

1. A method, comprising:
augmenting rule-based decision by adaptively partitioning artificial intelligence (AI) workloads across a federated inference infrastructure based on real-time assessments of device capabilities, network conditions, and workload requirements; and
partitioning inference demands, to distribute tasks while supporting mobile device heterogeneity.

2. The method of claim 1, the method further comprising:
analyzing computational capabilities of each mobile device, including available Central Processing Unit (CPU), Graphics Processing Unit (GPU), memory resources, and specialized AI inference System on Chips (SoCs);
continuously monitoring network conditions, including bandwidth and latency, to ensure efficient distribution of tasks; and
employing machine learning techniques to adaptively adjust workload partitioning based on historical data and real-time feedback.

3. The method of claim 2, the method further comprising:
dynamically balancing workload distribution across the federated inference infrastructure to prevent overloading and maximize processing efficiency by analyzing SoC characteristics.

4. The method of claim 3, the method further comprising:
employing rule-based decision and Large AI models to predict future workload demands and recommend task migration, wherein tasks are dynamically reassigned from overloaded devices to underutilized ones, ensuring optimal resource utilization across a federated network.

5. The method of claim 1, the method further comprising:
employing fault-tolerance strategies for the federated inference infrastructure, including mechanisms for detecting and handling device failures, network disruptions and well as characteristics of foundation models.

6. The method of claim 1, the method further comprising:
implementing rule-based decision around task replication and employing redundancy to mitigate impact of device failures or network disruptions.

7. The method of claim 6, the method further comprising:
utilizing machine learning to predict potential failures and proactively mitigating the potential failures to maintain uninterrupted AI inference.

8. A system, comprising:
a memory; and
a processor coupled to the memory, wherein the processor performs operations, the operations comprising:
augmenting rule-based decision by adaptively partitioning artificial intelligence (AI) workloads across a federated inference infrastructure based on real-time assessments of device capabilities, network conditions, and workload requirements; and
partitioning inference demands, to distribute tasks while supporting mobile device heterogeneity.

9. The system of claim 8, the operations further comprising:
analyzing computational capabilities of each mobile device, including available Central Processing Unit (CPU), Graphics Processing Unit (GPU), memory resources, and specialized AI inference System on Chips (SoCs);
continuously monitoring network conditions, including bandwidth and latency, to ensure efficient distribution of tasks; and
employing machine learning techniques to adaptively adjust workload partitioning based on historical data and real-time feedback.

10. The system of claim 9, the operations further comprising:
dynamically balancing workload distribution across the federated inference infrastructure to prevent overloading and maximize processing efficiency by analyzing SoC characteristics.

11. The system of claim 10, the operations further comprising:
employing rule-based decision and Large AI models to predict future workload demands and recommend task migration, wherein tasks are dynamically reassigned from overloaded devices to underutilized ones, ensuring optimal resource utilization across a federated network.

12. The system of claim 8, the operations further comprising:
employing fault-tolerance strategies for the federated inference infrastructure, including mechanisms for detecting and handling device failures, network disruptions and well as characteristics of foundation models.

13. The system of claim 8, the operations further comprising:
implementing rule-based decision around task replication and employing redundancy to mitigate impact of device failures or network disruptions.

14. The system of claim 13, the operations further comprising:
utilizing machine learning to predict potential failures and proactively mitigating the potential failures to maintain uninterrupted AI inference.

15. A computer program product, the computer program product comprising a computer readable storage medium, wherein code stored in the computer readable storage medium when executed by a processor performs operations, the operations comprising:
augmenting rule-based decision by adaptively partitioning artificial intelligence (AI) workloads across a federated inference infrastructure based on real-time assessments of device capabilities, network conditions, and workload requirements; and
partitioning inference demands, to distribute tasks while supporting mobile device heterogeneity.

16. The computer program product of claim 15, the operations further comprising:
analyzing computational capabilities of each mobile device, including available Central Processing Unit (CPU), Graphics Processing Unit (GPU), memory resources, and specialized AI inference System on Chips (SoCs);
continuously monitoring network conditions, including bandwidth and latency, to ensure efficient distribution of tasks; and
employing machine learning techniques to adaptively adjust workload partitioning based on historical data and real-time feedback.

17. The computer program product of claim 16, the operations further comprising:
dynamically balancing workload distribution across the federated inference infrastructure to prevent overloading and maximize processing efficiency by analyzing SoC characteristics.

18. The computer program product of claim 17, the operations further comprising:
employing rule-based decision and Large AI models to predict future workload demands and recommend task migration, wherein tasks are dynamically reassigned from overloaded devices to underutilized ones, ensuring optimal resource utilization across a federated network.

19. The computer program product of claim 15, the operations further comprising:
employing fault-tolerance strategies for the federated inference infrastructure, including mechanisms for detecting and handling device failures, network disruptions and well as characteristics of foundation models.

20. The computer program product of claim 15, the operations further comprising:
implementing rule-based decision around task replication and employing redundancy to mitigate impact of device failures or network disruptions.
